(19) United States
(12) Patent Application Publication
(10) Pub. No.: US 2007/0112084 A1
(43) Pub. Date: May 17, 2007

(54) Halogen-free, flame-retardant polyurethane foams

(75) Inventors: Jan-Gerd Hansel, Koln (DE); Heiko Tebbe, Dormagen (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/585,759

(22) Filed: Oct. 24, 2006

(30) Foreign Application Priority Data
Nov. 11, 2005 (DE) 10 2005 053 889.4

(51) Int. Cl. C08J 9/00

(52) U.S. Cl. 521/107

(57) ABSTRACT

The present invention relates to flame-retardant polyurethane foams which comprise, as flame retardant, halogen-free 2-hydroxyalkanephosphonates and/or 3-hydroxyalkanephosphonates.

This application claims the benefit of German Application No. DE 10 2005 053 889.4 filed Nov. 11, 2005.

The present invention relates to flame-retardant polyurethane foams which comprise, as flame retardant, 2-hydroxyalkanephosphonates and/or 3-hydroxyalkanephosphonates, and also to a process for production of these foams, and to their use.

### BACKGROUND OF THE INVENTION

Polyurethane foams are plastics used in many sectors, such as furniture, mattresses, transport, construction and technical insulation. In order to meet stringent flame retardancy requirements, for example those demanded for materials in sectors such as the automotive sector, railway sector and aircraft-interior-equipment sector, and also for insulation in buildings, polyurethane foams generally have to be modified with flame retardants. A wide variety of different flame retardants is known for this purpose and is commercially available. However, their use is complicated by a wide variety of considerable application-related problems or toxicological concerns.

For example, when solid flame retardants, e.g. melamine, aluminium hydroxide, ammonium polyphosphate and ammonium sulphate are used technical problems of metering arise and often necessitate modifications to the foaming systems, i.e. complicated reconstruction and adaptation measures.

Tris(chloroethyl) phosphate, tris(chloroisopropyl) phosphate and tris(2,3-dichloroisopropyl) phosphate are frequently used flame retardants, and are liquids that can easily be metered. However, halogen-free flame retardant systems are increasingly frequently preferred on grounds of environmental toxicity and also for reasons of improved side-effects in terms of smoke density and smoke toxicity in the event of a fire. Halogen-free flame retardants can also be of particular interest on performance grounds. For example, when halogenated flame retardants are used the plant components used for flame lamination of polyurethane foams are subject to marked corrosion. This can be attributed to the hydrogen halide emissions arising during flame lamination of halogen-containing polyurethane foams.

Flame lamination is the term used for a process for the bonding of textiles and foams, by using a flame for incipient melting of one side of a foam sheet and then immediately pressing a textile web onto this side.

Alkyl phosphates, such as triethyl phosphate, aryl phosphates, such as diphenyl cresyl phosphate, and alkyl phosphonates, such as dimethyl propanephosphonate, are used as liquid, halogen-free flame retardants in polyurethane foams.

A requirement increasingly placed upon open-cell flexible polyurethane foam systems for interior trim in automobiles is that the gaseous emissions (volatile organic compounds, VOC), and especially the condensable emissions (fogging) from these foams are not to exceed low threshold values. Because the abovementioned liquids have relatively low molecular weights, with resultant excessive volatility, they now fail to meet these requirements.

Fogging is the undesired condensation of vaporized volatile constituents on interior trim in a motor vehicle on panes of glass, in particular on the windscreen. DIN 75 201 permits quantitative assessment of this phenomenon. A typical requirement of the automobile industry is that fogging condensate is permitted to be less than 1 mg by the DIN 75 201 B method.

Reactive flame retardants can provide solutions in terms of low contributions to fogging. The term “reactive flame retardants” here means flame retardants which bear hydroxy groups reactive towards isocyanate groups. These react with the polyisocyanate used for foam production and are thus incorporated into the polyurethane. They therefore exhibit only very low contributions to fogging. There are numerous known reactive flame retardants based on chlorine compounds, on bromine compounds or on phosphorus compounds. Halogen-free, reactive flame retardants are preferred in many applications for the abovementioned reasons, an example being interior trim in automobiles. Since the flame retardancy of phosphorus compounds generally improves as phosphorus content rises, particular preference is given to reactive flame retardants with high phosphorus content.

DE 43 42 972 A1 (=U.S. Pat. No. 5,608,100) describes halogen-free, reactive flame retardants based on phosphoric esters. A product of this type from Clariant GmbH whose trademark is Exolit® OP 550 comprises 17% of phosphorus, and has a hydroxy number of 130 mg KOH/g and a viscosity of 2000 mPas (25° C.; see EP 1 142 939 B1, page 4, line 33). This high viscosity makes processing difficult on the conventional machinery used in polyurethane foam production.

DE 199 27 548 C2 (=U.S. Pat. No. 6,380,273) and EP 1 142 939 B1 (=U.S. Pat. No. 6,518,325) describe halogen-free, reactive phosphonic esters as flame retardants for polyurethane foams. These products comprise only from 12 to 13% of phosphorus, but have low viscosities of less than 300 mPas (25° C.). A disadvantage is the high hydroxy numbers, above 400 mg KOH/g, which makes it more difficult to process these reactive phosphonic esters to give defect-free foams.

The hydroxy number is a measure of the concentration of hydroxy groups in a substance. It gives, in mg, the amount of potassium hydroxide in which the molar amount of hydroxide ions is identical with that of hydroxy groups in 1 g of the substance.

High hydroxy numbers of a reactive flame retardant are disadvantageous, because it means that even very small amounts of flame retardant require appropriate modification of the formulation. The foam quality of a polyurethane foam is dependent on the balancing of the catalyst system with respect to the competing reactions of the polyisocyanates with the hydroxy groups present in the polyol, and, if appropriate, with the water. If a flame retardant that bears hydroxy groups is then introduced as a further reactive component, the result can be production defects, such as shrinkage or cracks. The catalyst system, which is often composed of a plurality of components, then has to be balanced with respect to the reactivity of the flame retardant by taking into account the stabilizers, blowing agents, cell regulators and, if appropriate, other constituents used. This balancing necessitates time-consuming development work.

The magnitude of the problems described becomes smaller as the hydroxy number decreases, and as the required usage amount of a reactive flame retardant becomes smaller. Preference is therefore given to reactive flame retardants having a low hydroxy number and/or having high activity, i.e. generally having high phosphorus content. There is also an economic advantage apparent with high-activity reactive flame retardants: it is not only the required usage amount of the flame retardant that is very small; the required additional amount of polyisocyanate for reaction with the flame retardant is also very small.

U.S. Pat. No. 3,385,801 and DE 19 744 426 A1 (CA 2 246 634) describe the use of 1-hydroxyalkanephosphonic esters, such as dimethyl 1-hydroxymethanephosphonate, as halogen-free, reactive flame retardants for polyurethane foams. Dimethyl 1-hydroxymethanephosphonate has an advantageous combination of properties, with hydroxy number of 382 mg KOH/g, viscosity of 20 mPas (25° C.) and phosphorus content of 22.1% (DE 197 44 426 A1, page 11, lines 14-15). However, a disadvantage is that 1-hydroxyalkanephosphonic esters are known to be labile with respect to alkaline hydrolysis, for example as described in Methoden der organischen Chemie [Methods of Organic Chemistry] (Houben-Weyl), Ed. Eugen Müller, Volume XII/1, page 477, Georg Thieme Verlag, Stuttgart, 4th edition 1963. This lability excludes 1-hydroxyalkanephosphonic esters from use in storage-stable polyol preparations which comprise water as blowing agent and comprise amines as catalyst.

U.S. Pat. No. 4,165,411 describes a flame-retardant polyurethane foam which is produced from a prepolymer containing isocyanate groups in the presence of from 6.5 to 390 mol of water per mole of isocyanate groups in the prepolymer. In this context, a prepolymer is the reaction product derived from at least one polyol and from at least one polyisocyanate, an excess of isocyanate groups being present here after complete reaction. These isocyanate groups of the prepolymer are available for further reactions, for example foaming with a blowing agent comprising water.

The polyurethane foams in U.S. Pat. No. 4,165,411 comprise, as flame retardant, based on the total weight of the dry foam, from 45 to 70% of aluminium hydroxide and from 2 to 20% of a phosphorus-containing flame retardant. The phosphorus-containing flame retardant can also be “dimethyl hydroxyethylphosphonate”. However, no formula and no preparation specification is stated for the substance “dimethyl hydroxyethylphosphonate”. It remains unclear, therefore, whether this is dimethyl 1-hydroxyethanephosphonate or dimethyl 2-hydroxyethanephosphonate.

The foam claimed in U.S. Pat. No. 4,165,411 has serious disadvantages. The foam cannot be produced in one stage, but has to be produced in a time-consuming manner by way of the prepolymer as intermediate stage. Since almost all of the applications require a dry foam, the large amount of excess water must in turn be removed by drying (U.S. Pat. No. 4,165,411, column 9, line 46). This is a lengthy and energy-intensive process. Furthermore, the large excess of water accelerates the foaming process to such an extent, as a consequence of hydrolysis of isocyanate groups, that no catalyst is then required. Although U.S. Pat. No. 4,165,411 regards that as an advantage, it is a disadvantage according to the current prior art, because conventional control of the properties of the foam via a balanced catalyst system becomes impossible. The large excess of water can inhibit complete incorporation of the flame retardant, when reactive flame retardants are used, since flame retardant and water compete for the limited amount of isocyanate. Finally, the requirement to use a large amount of aluminium hydroxide is disadvantageous, because metering of a solid is complicated and the aluminium hydroxide can form a sediment in the liquid reaction mixture, because its density, 2.4 g/ml, is higher than that of the other starting materials. The result can be non-uniform foams.

U.S. Pat. No. 4,165,411 says nothing about fogging.

It is object of the present invention to provide low-fogging halogen-free flame-retardant polyurethane foams which include flame retardants that are simple to process.

### DESCRIPTION OF THE INVENTION

Surprisingly, it has now been found that flame-retardant polyurethane foams can be produced using halogen-free hydroxyalkanephosphonic diesters as flame retardant, with no need for a prepolymer process and no need for the use of a large excess of water and no need for the simultaneous use of large amounts of aluminium hydroxide. A feature of these foams is that they are not only easy to produce but also give little fogging.

The present invention therefore provides flame-retardant polyurethane foams which are produced using halogen-free 2-hydroxyalkanephosphonic diesters and/or 3-hydroxyalkanephosphonic diesters as flame retardant, and using a blowing agent which comprises no more than 1 mol of water per mole of the isocyanate groups available for reaction with the water.

The term “halogen-free” means that the hydroxyalkanephosphonic diesters do not contain the elements fluorine, chlorine, bromine and/or iodine.

The inventive polyurethane foams preferably comprise 2-hydroxyalkanephosphonic diesters and/or 3-hydroxyalkanephosphonic diesters of the general formula (I) 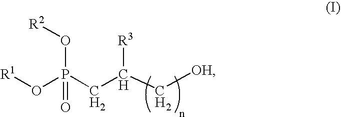
in which
R¹ and R² are, independently of one another, a C₁-C₈-alkyl, C₁-C₄-alkoxyethyl, or optionally C₁-C₄-alkyl-substituted C₆-C₁₀-aryl radical, or R¹ and R² together are an optionally C₁-C₄-alkyl-substituted, six-membered ring,
R³ is hydrogen or straight-chain or branched C₁-C₄-alkyl and
n is 0 or 1.

In another, particularly preferred embodiment, R¹ and R² are identical and are either methyl or ethyl.

In one particularly preferred embodiment, R³ is hydrogen or methyl.

The inventive polyurethane foams very particularly preferably comprise dimethyl 2-hydroxy-ethanephosphonate, formula (II), 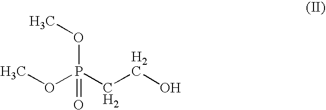
and/or diethyl 2-hydroxyethanephosphonate, formula (III),

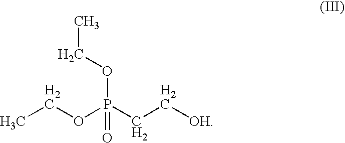

The 2-hydroxyalkanephosphonic diesters or 3-hydroxyalkanephosphonic diesters are preferably compounds that are liquid at the processing temperature. The processing temperature here means the temperature at which the polyurethane raw materials are introduced into the metering and mixing assemblies of the foam systems. Temperatures selected here are usually from 20 to 80° C. as a function of the viscosities of the components and the design of the metering assemblies.

The 2-hydroxyalkanephosphonic diesters or 3-hydroxyalkanephosphonic diesters preferably have low viscosity.

It is preferable that the 2-hydroxyalkanephosphonic diesters or 3-hydroxyalkanephosphonic diesters are reactive towards the isocyanates used in production of the polyurethane foams, and that they are therefore mainly present in a form bonded to the polyurethane by way of urethane groups, for example, rather than in unreacted form.

The inventive polyurethane foams are produced with use of blowing agents. Suitable blowing agents suitable are any of the substances commonly used for production of polyurethane foams. Examples here are water, volatile organic substances, e.g. n-pentane, isopentane, cyclopentane, halogen-containing alkanes, such as trichloromethane, methylene chloride or chlorofluoroalkanes, and also gases, e.g. CO₂. A mixture of a plurality of blowing agents can also be used.

If, in one particular embodiment of the present invention, the blowing agent comprises water, the amount of water used according to the invention is not more than 1 mol of water per mole of the isocyanate groups available for reaction with the water. In the context of the present invention, the molar amount of the isocyanate groups available for reaction with the water is the difference between the molar amount of all of the isocyanate groups used and the molar amount, with the exception of the water, of the hydrogen atoms reactive towards isocyanate groups. This stoichiometric calculation does not involve any conclusions concerning the actual reactions proceeding during foam production. For these purposes, it is of no importance whether the total amount of isocyanate groups is reacted in succession or simultaneously with polyol and water. If, as in the prepolymer process, the reaction takes place in succession, the molar amount of the isocyanate groups available for reaction with the water is identical with the molar amount of the isocyanate groups in the prepolymer.

In another, particularly preferred embodiment, the blowing agent comprises not more than 0.6 mol of water per mole of the isocyanate groups available for reaction with the water. The expression “not more than 1 mol or 0.6 mol” includes the value 0. According to the invention, there is no requirement that any water at all be present in the blowing agent.

The inventive, flame-retardant polyurethane foams are produced by reacting organic polyisocyanates with compounds having at least two hydrogen atoms reactive towards isocyanates, with the blowing agents mentioned, and also with conventional catalysts, stabilizers, activators and/or other conventional auxiliaries and additives in the presence of halogen-free 2-hydroxyalkanephosphonic diesters and/or 3-hydroxyalkanephosphonic diesters.

The amount of 2-hydroxyalkanephosphonic diester and/or 3-hydroxyalkanephosphonic diester present in the inventive polyurethane foams is preferably from 0.1 to 20% by weight, particularly preferably from 0.5 to 16% by weight, based on the finished polyurethane foam.

As described in U.S. Pat. No. 4,165,411, the presence of aluminium hydroxide is a substantial constituent of those foams. However, for the purposes of the present invention it has been found that although use of the 2-hydroxyalkanephosphonates and/or 3-hydroxyalkanephosphonates permits use of aluminium hydroxide, it is not essential. One preferred embodiment of the present invention therefore provides flame-retardant foams which comprise less than 40% by weight, preferably less than 20% by weight, particularly preferably less than 10% by weight, of aluminium hydroxide alongside halogen-free 2-hydroxyalkanephosphonic diesters and/or alongside 3-hydroxyalkanephosphonic diesters. As a function of the requirements placed upon the foams, the amount of aluminium hydroxide present is also 0. The invention further provides the use of halogen-free 2-hydroxyalkanephosphonic diesters and/or 3-hydroxyalkanephosphonic diesters as flame retardants for polyurethanes which comprise less than 40% by weight, preferably less than 20% by weight, in particular less than 10% by weight, of aluminium hydroxide.

The polyurethane foams are foams based on isocyanate, mainly having urethane groups and/or isocyanurate groups and/or allophanate groups and/or uretdione groups and/or urea groups and/or carbodinde groups. The production of foams based on isocyanate is known and is described by way of example in DE-A 16 94 142 (=GB 1 211 405), DE-A 16 94 215 (=U.S. Pat. No. 3,580,890) and DE-A 17 20 768 (=U.S. Pat. No. 3,620,986), and also in Kunststoff-Handbuch [Plastics Handbook] Volume VII, Polyurethane [Polyurethanes], edited by G. Oertel, Carl-Hanser-Verlag Munich, Vienna, 1993.

Polyurethane foams are broadly divided into flexible and rigid foams. Although flexible and rigid foams can in principle have approximately the same envelope density and constitution, flexible polyurethane foams have only a very low degree of crosslinking and have only a very low resistance to deformation under pressure. In contrast to this, the structure of rigid polyurethane foams is composed of high crosslinked units, and rigid polyurethane foam has very high resistance to deformation under pressure. The typical rigid polyurethane foam is of closed-cell type and has a low coefficient of thermal conductivity. In the production of polyurethanes, which proceeds by way of the reaction of polyols with isocyanates, the subsequent structure of the foam and its properties are influenced primarily by way of the structure and molar mass of the polyol and also by way of the reactivity and number (functionality) of the hydroxy groups present in the polyol. Further details concerning rigid and flexible foams and the starting materials that can be used for their production, and also concerning processes for their production, are found in Norbert Adam, Geza Avar, Herbert Blankenheim, Wolfgang Friederichs, Manfred Giersig, Eckehard Weigand, Michael Halfmann, Friedrich-Wilhelm Wittbecker, Donald-Richard Larimer, Udo Maier, Sven Meyer-Ahrens, Karl-Ludwig Noble and Hans-Georg Wussow: “Polyurethanes”, Ullmann's Encyclopedia of Industrial Chemistry Release 2005, Electronic Release, 7th ed., chap. 7 (“Foams”), Wiley-VCH, Weinheim 2005.

The envelope densities of the inventive polyurethane foams are preferably from 16 to 130 kg/m³. Their envelope densities are particularly preferably from 20 to 40 kg/m³.

The following starting components are used for production of the isocyanate-based foams:
1. Aliphatic, cycloaliphatic, araliphatic, aromatic and heterocyclic polyisocyanates (e.g. W. Siefken in Justus Liebigs Annalen der Chemie, 562, pp. 75-136), for example those of the formula Q(NCO)ₙ, in which n=from 2 to 4, preferably from 2 to 3, and Q is an aliphatic hydrocarbon radical having from 2 to 18, preferably from 6 to 10, carbon atoms, a cycloaliphatic hydrocarbon radical having from 4 to 15, preferably from 5 to 10, carbon atoms, an aromatic hydrocarbon radical having from 6 to 15, preferably from 6 to 13, carbon atoms, or an araliphatic hydrocarbon radical having from 8 to 15, preferably from 8 to 13, carbon atoms. Particular preference is generally given to the polyisocyanates which are readily accessible industrially and which derive from tolylene 2,4- and/or 2,6-diisocyanate or from diphenylmethane 4,4′- and/or 2,4′-diisocyanate.
2. Compounds having at least two hydrogen atoms reactive towards isocyanates and whose molar mass is from 400 to 8000 g/mol (“polyol component”). These are not only compounds having amino groups, thio groups or carboxy groups, but also preferably compounds having hydroxy groups, in particular compounds having from 2 to 8 hydroxy groups. If the polyurethane foam is intended to be a flexible foam, it is preferable to use polyols whose molar masses are from 2000 to 8000 g/mol and which have from 2 to 6 hydroxy groups per molecule. The polyol mixture for production of the flexible foams can also comprise relatively small proportions of polyetherester polyols whose molar masses are from 240 to 1200 g/mol and which contain from 2 to 3 hydroxy groups per molecule. If, in contrast, the intention is to produce a rigid foam, it is preferable to use highly branched polyols whose molar masses are from 400 to 1000 g/mol and which have from 2 to 8 hydroxy groups per molecule. The polyols are polyethers, polyesters or polyetheresters, or else polycarbonates and polyesteramides, as are known for production of homogeneous and cellular polyurethanes and as are described by way of example in DE-A 28 32 253 (=U.S. Pat. No. 4,263,408) and in EP 1 555 275 A2 (=US 2005 159 500). According to the invention, preference is given to the polyesters and polyethers having at least two hydroxy groups.

The inventive polyurethane foams can therefore be produced in the form of rigid or flexible foams by selecting the starting materials appropriately in a manner easily found in the prior art.

Other starting components that can be used, if appropriate, are compounds having at least two hydrogen atoms reactive towards isocyanates and having a molecular weight of from 32 to 399. Here again, these are compounds having hydroxy groups and/or amino groups and/or thio groups and/or carboxy groups, preferably compounds having hydroxy groups and/or amino groups, which serve as chain extenders or crosslinking agents. These compounds generally have from 2 to 8, preferably from 2 to 4, hydrogen atoms reactive towards isocyanates. Examples are likewise described in DE-A 28 32 253 (=U.S. Pat. No. 4,263,408).
3. If appropriate, concomitant use is made of auxiliaries and additives, such as catalysts of the known type, surfactant additives, such as emulsifiers and foam stabilizers, reaction retarders, e.g. substances having acidic reaction are for example hydrochloric acid or organic acid halides, or else cell regulators of the known type, such as paraffins or fatty alcohols and dimethylpolysiloxanes, or else pigments or dyes, and other flame retardants, or else stabilizers to counteract the effects of ageing and weathering, core-discolouration inhibitors, plasticizers and substances having fungistatic and bacteriostatic action, and also fillers, such as barium sulphate, kieselguhr, carbon black or whiting (DE-A 27 32 292/U.S. Pat. No. 4,248,930). Particular core-discolouration inhibitors that can be present are sterically hindered trialkylphenols, alkyl esters of 3-(3,5-di-tert-butyl-4-hydroxyphenyl)propionic acid, benzofuran-2-ones, secondary aromatic amines, phosphites, phenothiazines or tocopherols.

Other flame retardants which can be present in the polyurethane foams alongside the 2-hydroxyalkanephosphonic diesters and/or 3-hydroxyalkanephosphonic diesters to be used according to the invention are
a) organophosphorus compounds, such as triethyl phosphate, triphenyl phosphate, diphenyl cresyl phosphate, tricresyl phosphate, isopropylated or butylated aryl phosphates, aromatic bisphosphates, neopentyl glycol bis(diphenyl phosphate), chlorine-containing phosphoric esters, e.g. tris(chloroisopropyl) phosphate or tris(dichloropropyl) phosphate, dimethyl methanephosphonate, diethyl ethanephosphonate, dimethyl propanephosphonate, oligomeric phosphates or phosphonates, phosphorus compounds containing hydroxy groups, 5,5-dimethyl-1,3,2-dioxaphosphorinane 2-oxide derivatives,
b) phosphorus compounds of salt type, such as ammonium phosphate, ammonium polyphosphate, melamine phosphate, melamine polyphosphate, metal salts of dialkylphosphinic acids, metal salts of alkanephosphonic acids,
c) nitrogen compounds, such as melamine, melamine cyanurate,
d) chlorine compounds and bromine compounds, examples being alkyl esters of a tetrabromobenzoic acid, bromine-containing diols prepared from tetrabromophthalic anhydride, bromine- and/or chlorine-containing polyols, bromine-containing diphenyl ethers, or
e) inorganic flame retardants, such as aluminium hydroxide, boehmite, magnesium hydroxide, expandable graphite or clay minerals.

Other examples of materials to be used concomitantly according to the invention, if appropriate, in the form of surfactant additives and foam stabilizers and also cell regulators, reaction retarders, stabilizers, flame-retardant substances, plasticizers, dyes and fillers and also substances having fungistatic and/or bacteriostatic action are described in Kunststoff-Handbuch [Plastics handbook], Volume VII, Carl-Hanser-Verlag, Munich, 1993, on pages 104-123, as also are details concerning use of these additives and their mode of action.

The present invention also preferably provides a process for production of flame-retardant polyurethane foams via reaction of organic polyisocyanates with compounds having at least two hydrogen atoms reactive towards isocyanates, and with conventional catalysts, stabilizers, activators and/or other conventional auxiliaries and additives at from 20 to 80° C., characterized in that an amount of from 0.1 to 40 parts, preferably from 1 to 30 parts, based on 100 parts of polyol component, of halogen-free 2-hydroxyalkanephosphonic diester and/or 3-hydroxyalkane-phosphonic diester are used as flame retardant, and in that not more than 1 mol of water per mole of the isocyanate groups available for reaction with the water is used as blowing agent.

In another preferred embodiment, the inventive process uses 2-hydroxyalkanephosphonic diester and/or 3-hydroxyalkanephosphonic diester of the general formula (I) 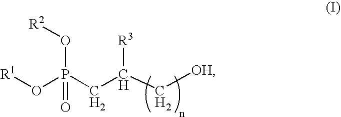
in which
R¹ and R² are, independently of one another, a C₁-C₈-alkyl, C₁-C₄-alkoxyethyl, or optionally C₁-C₄-alkyl-substituted C₆-C₁₀-aryl radical, or R¹ and R² together are an optionally C₁-C₄-alkyl-substituted, six-membered ring,
R³ is hydrogen or straight-chain or branched C₁-C₄-alkyl and
n is 0 or 1.

In another, particularly preferred embodiment, R¹ and R² are identical and are either methyl or ethyl.

In one particularly preferred embodiment, R³ is hydrogen or methyl.

The inventive process very particularly preferably uses dimethyl 2-hydroxyethanephosphonate, formula (II), 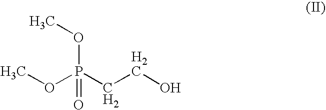
and/or diethyl 2-hydroxyethanephosphonate, formula (III),

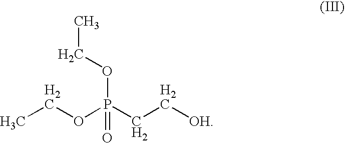

In the conduct of the inventive process, the reaction components described above are reacted by the known single-stage process, or by the prepolymer process or by the semiprepolymer process, often using machinery such as that described by way of example in U.S. Pat. No. 2,764,565. Details concerning process equipment which can also be used according to the invention are described in Kunststoff-Handbuch [Plastics Handbook] Volume VII, Polyurethane [Polyurethanes], edited by G. Oertel, Carl-Hanser-Verlag, Munich, Vienna 1993, on pages 139-192.

Cold-curing foams can also be produced (GB Patent 11 62 517, DE-A 21 53 086) according to the inventive process. However, it is also possible, of course, to produce foams via slab foaming or via the twin-conveyor-belt process known per se. Polyisocyanurate foams are produced by using the processes and conditions known for that purpose.

The inventive process permits production of flame-retardant polyurethane foams in the form of rigid or flexible foams in continuous or batch production mode or in the form of foamed shaped products. The inventive process is preferred in production of flexible foams which are produced via a slab foaming process.

Examples of the use of the products available according to the invention are as follows: furniture padding, textile inserts, mattresses, seats, preferably aircraft seats or automobile seats, armrests and modules, and also seat coverings and cladding over technical equipment.

The 2-hydroxyalkanephosphonic diesters and/or 3-hydroxyalkanephosphonic diesters present in the inventive polyurethane foams or used in the inventive process are either known or can be prepared by known methods. Starting materials used here are available on an industrial scale and permit simple production of the desired end products.

The compound dimethyl 2-hydroxyethanephosphonate, formula (II), CAS Reg. No. 54731-72-5, is commercially available and can be prepared from dimethyl 2-acetoxyethanephosphonate and methanol in the presence of an acidic ion exchanger, as described in DE-A 2 313 355, Example 1.

U.S. Pat. No. 3,699,195, Example 1, describes the preparation of the compound diethyl 2-hydroxyethane-phosphonate, formula (m), CAS Reg. No. 39997-40-5, from diethyl phosphite, sodium and ethylene oxide.

The liquid 2-hydroxyalkanephosphonic diesters or 3-hydroxyalkanephosphonic diesters have low viscosities and are therefore easy to meter. Their high phosphorus content gives them high activity, and use of even small amounts therefore permits production of foams which not only meet the flame retardancy requirements but also have particularly low fogging values.

The examples below provide further explanation of the invention, but there is no intention that they restrict the invention.

### EXAMPLES

Flexible Polyurethane Foam

The parts stated are based on weight.

Materials used

| Component | Function | Description |
|---|---|---|
| A | Polyol | Arcol ® 1105 (Bayer MaterialScience AG), |
| | | Polyether polyol whose OH number is 56 mg KOH/g |
| B | Blowing agent | Water |
| C | Catalyst | Niax ® A-1 (GE Silicones), 70% strength solution of |
| | | bis(2-dimethylaminoethyl) ether in dipropylene glycol |
| D | Catalyst | Desmorapid ® SO (Rhein Chemie), stannous 2-ethylhexanoate |
| E | Catalyst | RC-PUR ® Activator 105 (Rhein Chemie), solution of |
| | | triethylenediamine in dipropylene glycol |
| F1 | Flame retardant | Tris(2,3-dichloroisopropyl)phosphate, TDCP, |
| | | CAS Reg. No. 13674-87-8 |
| F2 | Flame retardant | Diphenyl cresyl phosphate, CAS Reg. No. 26444-49-5 |
| F3 | Flame retardant | Dimethyl 2-hydroxyethanephosphonate, formula (II), |
| | | CAS Reg. No. 54731-72-5 |
| G | Stabilizer | Tegostab ® B 8232 (Degussa AG), silicone stabilizer |
| H | Diisocyanate | Desmodur ® T 80 (Bayer MaterialScience AG), |
| | | tolylene diisocyanate, isomer mixture |
| I | Diisocyanate | Desmodur ® T 65 (Bayer MaterialScience AG), |
| | | tolylene diisocyanate, isomer mixture |

The acid number of the dimethyl 2-hydroxyethanephosphonate used was 0.07 mg KOH/g, its hydroxy number was 364 mg KOH/g, its water content was 0.01%, its viscosity was 22 mPas at 23° C. and its phosphorus content was 20%.

Production of Flexible Polyurethane Foams

The components whose nature and amount is stated in Table 1, with the exception of the diisocyanate (components H and I) were mixed to give a homogeneous mixture. The diisocyanate was then added and incorporated by brief and intensive stirring. After a cream time of from 15 to 20 s and a full rise time of from 130 to 140 s, the product was a flexible polyurethane foam whose envelope density was 31 kg/m³.

Determination of Flame Retardancy

The flexible polyurethane foams were tested to the specifications of the Federal Motor Vehicle Safety Standard FMVSS-302. In this test, foam test specimens of dimensions 210 mm×95 mm ×15 mm (L×W×H) secured in a horizontal holder were ignited centrally on the short edge for 15 s by a gas burner flame of height 40 mm, and once the ignition flame had been removed the spread of flame was observed. As a function of whether and to what extent the test specimen continued to burn, the test specimen was allocated to fire classes SE (self-extinguishing, less than 38 mm of the specimen burned), SE/NBR (self-extinguishing within 60 s/no burning rate stated), SE/B (self-extinguishing/measurable burning rate), BR (burns to end of specimen, measurable burning rate) and RB (rapid burning, burning rate not measurable). The fire tests were carried out five times for each example. The poorest result of each series of five is given in Table 1.

Determination of Fogging

The fogging performance of the flexible polyurethane foams was studied to DIN 75201 B. In this test, cylindrical foam test specimens of dimensions 80 mm×10 mm (ø×H) were heated to 100° C. for 16 h, and the amount of condensate deposited during this time on an aluminium foil positioned above the test specimen and cooled to 21° C. was determined by weighing. The amounts of condensate measured are given in Table 1.

TABLE 1
Constitution (parts) and test results for Inventive Example IE1
and for non-inventive Comparative Examples CE1-CE3

| | Example | | | |
|---|---|---|---|---|
| | CE1 | CE2 | CE3 | E1 |
| A | 100 | 100 | 100 | 100 |
| B | 4.0 | 4.0 | 4.0 | 4.0 |
| C | 0.10 | 0.10 | 0.10 | 0.10 |
| D | 0.16 | 0.16 | 0.16 | 0.16 |
| E | 0.20 | 0.20 | 0.20 | 0.20 |
| G | 1.30 | 1.30 | 1.30 | 1.30 |
| F1 | | 4 | | |
| F2 | | | 4 | |
| F3 | | | | 4 |
| H | 25.3 | 25.3 | 25.3 | 26.5 |
| I | 25.3 | 25.3 | 25.3 | 26.5 |
| Index | 106.5 | 106.5 | 106.5 | 106.5 |
| Water/isocyanate*) | 0.46 | 0.46 | 0.46 | 0.46 |
| MVSS class | RB | SE | BR | SE |
| Fogging condensate [mg] | 0.14 | 0.38 | 0.36 | 0.18 |
| to DIN 75201 B | | | | |

*)mol of water per mole of the isocyanate groups available for reaction with the water

Results

In the absence of any flame retardant (Comparative Example CE1), the flexible polyurethane foam burns rapidly (RB), but has a very low fogging value. Modification with the frequently used flame retardant tris(2,3-dichloroisopropyl)phosphate (Comparative Example CE2) gives increased fogging (0.38) and brings the disadvantages described above for a halogen-containing flame retardant. Although use of the halogen-free flame retardant diphenyl cresyl phosphate (Comparative Example CE3) circumvents this problem, flame retardancy is inadequate (BR). Inventive Example 1 (IE1) shows that the inventive, halogen-free flexible polyurethane foams feature the best fire class SE (self-extinguishing) in all of the repeats of the fire test, and feature a very low fogging value (0.18).

Rigid Polyurethane Foam

The parts stated are based on weight.

Materials used

| Component | Function | Description |
|---|---|---|
| A | Polyol | Stepanol ® PS-2352 (Stepan), |
| | | Polyester polyol whose OH number is 240 mg KOH/g |
| B | Blowing agent | Water |
| C | Blowing agent | n-pentane |
| D | Catalyst | DABCO ® K-15 (Air Products), potassium octoate formulation |
| E | Catalyst | DABCO ® 2097 (Air Products), potassium acetate formulation |
| G | Catalyst | Polycat ® 5 (Air Products), pentamethyldiethylenetriamine |
| H | Stabilizer | DABCO ® DC-5598 (Air Products), silicone stabilizer |
| I | Diisocyanate | Desmodur ® 44 V 40 L (Bayer MaterialScience AG), polymeric |
| | | diphenylmethane diisocyanate, isocyanate content: 31.5% by |
| | | weight |
| F1 | Flame retardant | Tris(chloroisopropyl)phosphate, TCPP, |
| | | CAS Reg. No. 13674-84-5 |
| F2 | Flame retardant | Triethylphosphate, TEP, |
| | | CAS Reg. No. 78-40-0 |
| F3 | Flame retardant | Dimethyl 2-hydroxyethanephosphonate, formula (II), |
| | | CAS Reg. No. 54731-72-5 |

Production of Rigid Polyurethane Foams

The components whose nature and amount is stated in Table 2, with the exception of the diisocyanate (component I) were mixed to give a homogeneous mixture. The diisocyanate was then added and incorporated by brief and intensive stirring. After a cream time of from 10 to 15 s and a full rise time of from 40 to 50 s, the product was a rigid polyurethane foam whose envelope density was 28 kg/m³.

Determination of Flame Retardancy

The rigid polyurethane foams were tested to the specifications of DIN 4102-1. In this test, foam test specimens of dimensions 190 mm×90 mm×15 mm (L×W×H) secured edgewise in a vertical holder were ignited centrally on the lower edge for 15 s by a gas burner flame of height 20 mm directed obliquely onto the test specimen, and the average flame height on the test specimen was measured. The average flame height and the resultant allocation to fire classes B2 (normal flammability) and B3 (high flammability) are given in Table 2. The smaller the average flame height, the greater the effectiveness of the flame retardant.

TABLE 2
Constitution (parts) and test results tor Inventive Example IE2
and for non-inventive Comparative Examples CE5-CE6

| | Example | | |
|---|---|---|---|
| | CE5 | CE6 | IE2 |
| A | 100 | 100 | 100 |
| B | 0.5 | 0.5 | 0.5 |
| C | 24.3 | 24.3 | 24.3 |
| D | 1.9 | 1.9 | 1.9 |
| E | 0.35 | 0.35 | 0.35 |
| G | 0.25 | 0.25 | 0.25 |
| H | 2.5 | 2.5 | 2.5 |
| I (index 300) | 205 | 205 | 263 |
| F1 | 25 | | |
| F2 | | 25 | |
| F3 | | | 25 |
| Water/isocyanate*) | 0.03 | 0.03 | 0.02 |
| DIN 4102-1 class | B2 | B3 | B2 |
| Average flame height | 143 | 146 | 121 |
| [mm] | | | |

*)mol of water per mole of the isocyanate groups available for reaction with the water

Results

The results show that a B2 classification is achieved with the halogen-containing flame retardant TCPP (Comparative Example CE5), while only the classification B3 can be achieved with the same amount of the halogen-free flame retardant TEP (Comparative Example CE6). Inventive Example IE2 with the inventive halogen-free flame retardant achieves, in contrast, the classification B2 with a markedly lower average flame height than in Comparative Examples CE5 and CE6.

What is claimed is:

1. A flame-retardant polyurethane foam, wherein during its production halogen-free 2-hydroxyalkanephosphonic diesters and/or 3-hydroxyalkanephosphonic diesters are used as flame-retardants and a blowing agent which comprises not more than 1 mol of water per mole of the isocyanate groups available for reaction with the water is used.

2. A flame-retardant polyurethane foam according to claim 1, comprising 2-hydroxy-alkanephosphonic diesters and/or 3-hydroxyalkanephosphonic diesters of the general formula (I) 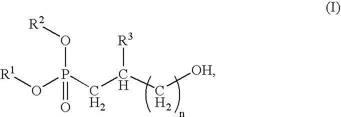
in which
R¹ and R² are, independently of one another, C₁-C₈-alkyl, C₁-C₄-alkoxyethyl, optionally C₁-C₄-alkyl-substituted C₆-C₁₀-aryl, or R¹ and R² together are an optionally C₁-C₄-alkyl-substituted, six-membered ring,
R³ is hydrogen or straight-chain or branched C₁-C₄-alkyl and
n is 0 or 1.

3. A flame-retardant polyurethane foam according to claim 1 and/or 2, comprising dimethyl 2-hydroxyethanephosphonate or diethyl 2-hydroxyethanephosphonate as a flame retardant.

4. A flame-retardant polyurethane foam according to claim 1, comprising an amount of from 0.1 to 20% by weight based on the finished polyurethane foam, of 2-hydroxyalkane-phosphonic diester and/or 3-hydroxyalkanephosphonic diester.

5. A flame-retardant polyurethane foam according to claim 1, wherein these are flexible foams or rigid foams.

6. A process for production of flame-retardant polyurethane foams via reaction of organic polyisocyanates with compounds having at least two hydrogen atoms reactive towards isocyanates, and with conventional catalysts, stabilizers, activators and/or other conventional auxiliaries and additives at from 20 to 80° C., wherein an amount of from 0.1 to 40 parts, preferably from 1 to 30 parts, based on 100 parts of polyol component, of halogen-free 2-hydroxyalkanephosphonic diester and/or 3-hydroxyalkanephosphonic diester are used as flame retardant, and a blowing agent is used comprising not more than 1 mol of water per mole of the isocyanate groups available for reaction with the water.

7. A process according to claim 6, wherein 2-hydroxyalkanephosphonic diesters and/or 3-hydroxyalkanephosphonic diesters are compounds that are liquid at the processing temperature.

8. A process according to claim 7, wherein dimethyl 2-hydroxyethanephosphonate or diethyl 2-hydroxyethanephosphonate is used as flame retardant.
